(19) United States
(12) Patent Application Publication
(10) Pub. No.: US 2003/0012413 A1
(43) Pub. Date: Jan. 16, 2003

(54) Iris identification apparatus and iris image pickup apparatus

(75) Inventors: Takashi Kusakari, Yokohama-shi (JP); Koji Wakiyama, Yokohama-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 10/195,342

(22) Filed: Jul. 15, 2002

(30) Foreign Application Priority Data
Jul. 16, 2001 (JP) P. 2001-215514

(51) Int. Cl. G06K 9/00

(52) U.S. Cl. 382/117

(57) ABSTRACT

In iris identification apparatus for performing personal identification by way of a shot iris image, a plurality of images are shot by using a camera whose quantity of a visible light included in an illuminating light irradiated onto a person to be shot differs from each other. The presence of a variation in the pupil diameter in the plurality of iris images is determined by a pupil size comparison processor. In case a variation in the pupil diameter is determined, personal identification by an iris identification processor based on any one of the plurality of iris images. Preferably, light emitting diodes for emitting a green light as a source of a visible light are used.

### BACKGROUND OF THE INVENTION

The present invention relates to iris identification apparatus and iris image pickup apparatus and in particular to iris identification apparatus and iris image pickup apparatus preferable for preventing cheating in identification by forgery.

In a security system, as described in the Japanese Patent Publication No. Hei. 8-504979 and the Japanese Patent Publication No. 2000-23946, a method is known to perform identification by using the wave pattern of the iris of an individual. This method of using an iris, unlike a method using fingerprints, has an advantage of completing identification by way of image pickup of an iris in a non-contact way, by using a camera from a distance. Thus the method is expected to be diffused in future.

This approach is subject to cheating in identification by forgery wherein the iris image of another person is printed on a photograph or an artificial eye for iris identification. It is thus necessary to provide iris identification apparatus with a feature to get rid of such cheating in identification by forgery.

It is known that, contraction of a pupil needs to be detected by emitting light beams onto the pupil intermittently in order to determine whether an iris image shot by the camera of iris identification apparatus is a forged image (see for example, “Iris Recognition System” by Yasuharu Kamei and Kazuhiko Ohnuma, published in pages 325-329 of “Optical Sensing Technology Current Databook”) In order to acquire a clear image of an iris with high recognition rate, it is necessary to irradiate a near infrared light onto a pupil for image pickup. A pupil is not likely to react with a near infrared light so that a visible light must be used with a near infrared light in order to check for pupillary reflex.

Because it is not permitted to keep a person to be identified before iris identification apparatus, it is necessary to simultaneously check for pupillary reflex and acquire a clear iris image within a short iris image acquisition time.

### SUMMARY OF THE INVENTION

The object of the invention is to provide iris identification apparatus and iris image pickup apparatus capable of detecting pupillary reflex and acquiring a clear iris image within a short time.

The foregoing object is attained, in performing personal identification through picked-up iris image, by shooting a plurality of images whose quantity of a visible light included in an illuminating light irradiated onto a person to be shot differs from each other, determining the presence of a variation in the pupil diameter in the plurality of iris images, and performing personal identification by using any one of the plurality of iris images in case a variation in the pupil diameter is determined.

With this configuration, it is determined that the image under identification has been forged in case a variation in the pupil diameter is not detected.

Preferably, a variation in the pupil diameter is determined by comparing an iris image acquired by irradiating a natural light as the illuminating light onto a person under identification and another acquired by irradiating an illuminating light including the natural light and a visible light onto the person. This reduces the irradiation count of an illuminating light thus saving power consumption.

Preferably, the source of the visible light is a light emitting diode for emitting a green light. This is because such visible light has a sensitivity peak around a waveform of 550 nm and appears in green around 550 nm. With this configuration, the pupillary reflex is made more remarkable thus upgrading the accuracy of determining whether the image acquired is forged or normal.

More preferably, the light emitting diode emitting a near infrared light is used with the visible light and the near infrared light and the visible light are simultaneously irradiated onto the iris to shoot an iris image. With this configuration, it is possible to acquire pupillary reflex efficiently and shoot a good iris image by using a small light source.

More preferably, the iris image of an iris having the smallest pupil diameter among the plurality of iris images for determining the presence of a variation in the pupil diameter is used for the personal identification. With this configuration, processing time to acquisition of an iris image for personal identification is shortened thus relieving the target person off the load of identification.

### BRIEF DESCRIPTION OF THE DRAWINGS

FIG. 1 is a front view of iris image pickup apparatus used with iris identification apparatus according to an embodiment of the invention;

FIG. 2 is a perspective view of iris image pickup apparatus used with iris identification apparatus according to an embodiment of the invention;

FIG. 3 is a flowchart showing the procedure of the iris image pickup and identification procedures;

FIG. 4 explains an image shot by a wide angle camera used in iris identification apparatus according to an embodiment of the invention;

FIG. 5 explains an image shot by a narrow angle camera used in iris identification apparatus according to an embodiment of the invention;

FIG. 6 is a general block diagram of iris identification apparatus according to an embodiment of the invention;

FIG. 7 is a flowchart of the procedure of iris identification apparatus according to an embodiment of the invention;

FIG. 8 is a general block diagram of iris identification apparatus according to another embodiment of the invention; and

FIG. 9 is a flowchart of the procedure of iris identification apparatus according to an embodiment of the invention.

### DETAILED DESCRIPTION OF THE PREFERRED EMBODIMENT An embodiment of the invention will be described referring to the drawings.

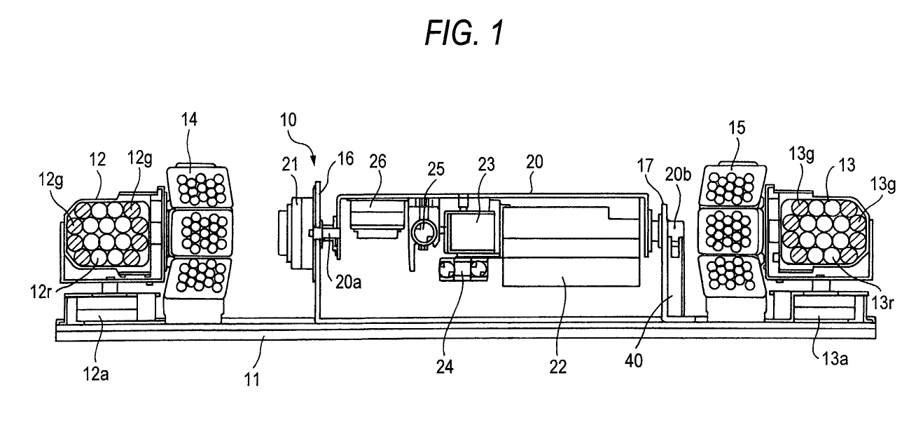

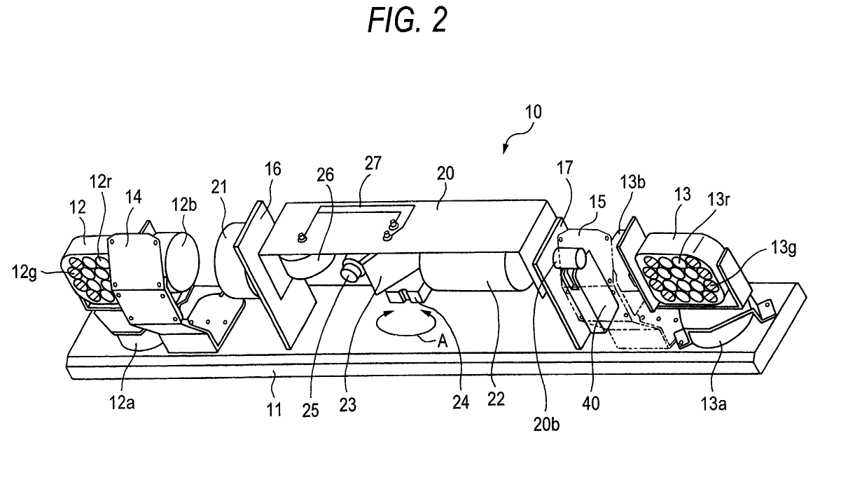

FIG. 1 is a front view of iris image pickup apparatus provided with iris identification apparatus according to an embodiment of the invention. FIG. 2 is a perspective view thereof. In each of FIGS. 1 and 2, an external panel is not shown.

The iris image pickup apparatus 10 according to the invention has a longitudinal fixed table 11. On each of the left and right ends of the longitudinal fixed table 11 are attached iris lighting fixtures 12, 13. Each iris lighting fixture 12, 13 includes a condensing lens for condensing and irradiating a near infrared light and a visible light onto the iris and pan motors for lighting 12a, 13a and tilt motors for lighting 12b, 13b in order to orient the illuminating light in the direction of the iris.

The iris lighting fixtures 12, 13 according to the invention includes diodes 12g, 13g for emitting a light having a wavelength of some 500 nm appearing in green (diagonally shaded areas in FIG. 1) and diodes 12r, 13r for emitting a near infrared light having a wavelength of some 500 nm for shooting an iris image. An illumination controller not shown in the figure can control irradiation by these diodes simultaneously or separately.

On the inner side from each iris lighting fixtures 12, 13 (in the center direction of the fixed table 11), lighting fixtures for wide angle cameras 14, 15 are attached. The lighting fixtures for wide angle cameras 14, 15 are configured as an aggregation of a large number of light emitting diodes. Those light emitting diodes are not shown and only the mounting plate for attaching the light emitting diodes is shown in the perspective view of FIG. 2. The lighting fixtures 14, 15 are secured to the fixed table 11 and no condensing lenses are provided, because they have only to illuminate a wide range evenly with a near infrared light (no panning or tilt operation is required).

On the inner side from the lighting fixture 14 (in the center direction of the fixed table 11), a support plate 16 is erected. On the inner side from the lighting fixture for wide angle cameras 15 (in the center direction of the fixed table 11) a support plate 17 is erected. Between both support plates 16, 17 is attached a tilt table 20.

The tilt table 20 includes axes 20a, 20b on the left and right respectively. Each axis 20a, 20b is respectively supported rotatably on the support plates 16, 17. One axis 20a is directly coupled to the rotation axis of the motor for tilt 21 attached to the support plate 16. A damper 40 is attached on the other axis 20b.

The tilt table 20 mounts a telephotograph camera (narrow angle camera) 22, a mirror for panning 23, a range finder (range sensor) 24, a wide angle camera 25, and a motor for panning 26. A telephotograph camera 22 is arranged on the support plate 17 of the tilt table 20 so that the light axis may be coaxial with the rotation axis of the tilt table. The mirror for panning 23 is arranged in front of the telephotograph camera 22. A light reflected on the mirror for panning 23 is entered to the telephotograph camera 22. The mirror for panning 23 is rotatable about the axis perpendicular to the light axis of the telephotograph camera 22, that is in the direction of a double-headed arrow A in FIG. 2.

The motor for panning 26 for rotating the mirror for panning 23 in the direction of the arrow A is attached to the support plate 16 of the tilt table 20 and drives the mirror for panning 23 via the link mechanism 27. The range finder 24, interlocked with the mirror for panning 23, is driven in the direction of the arrow A and irradiates an infrared light onto an object face to face thus allowing high-accuracy ranging. The range finder 24 is also driven by the motor for panning via the link mechanism 27.

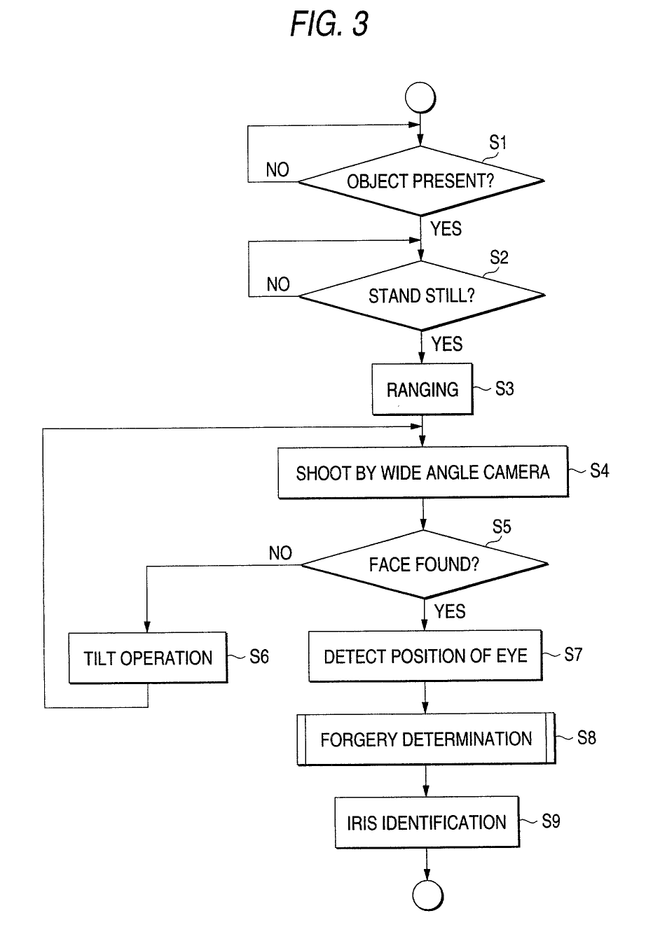

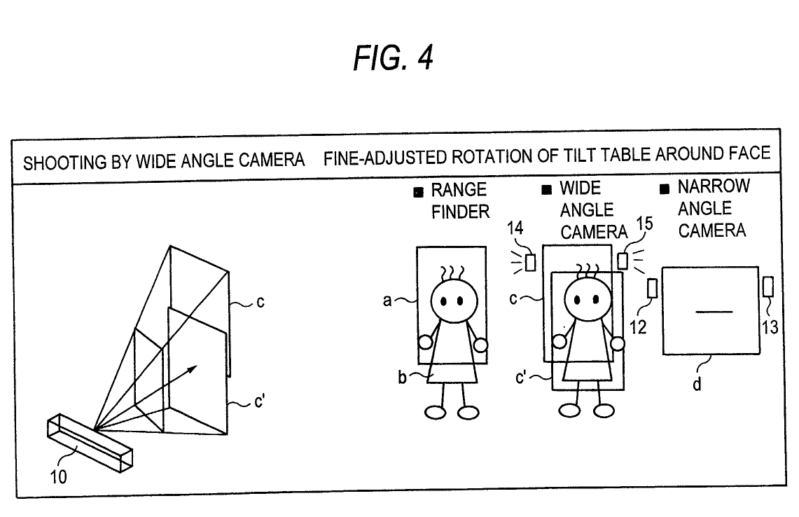

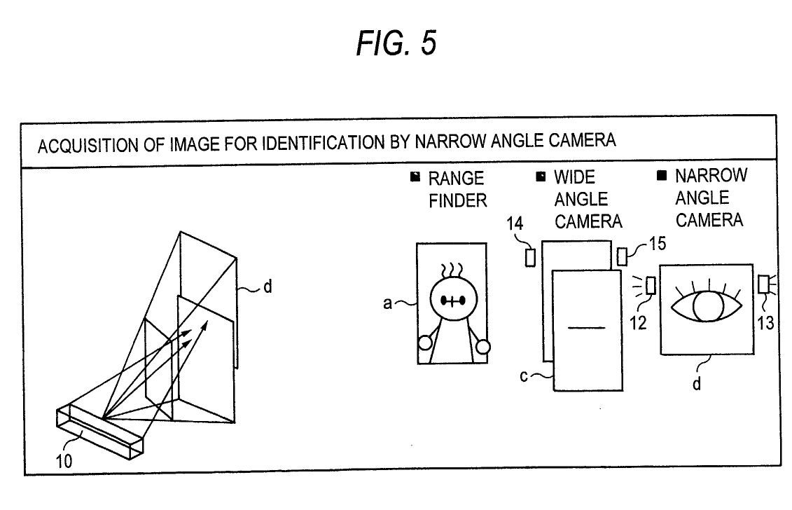

FIG. 3 is a flowchart showing the image pickup procedure of the iris image pickup apparatus 10. FIGS. 4 and 5 are conceptual drawings explaining the procedure from ranging of the object to iris image pickup of the object. The iris image pickup apparatus 10 waits for a person to enter the angle of view of the wide angle camera 25 (step S1). Various set values of the iris image pickup apparatus 10 are default values.

The iris image pickup apparatus 10, automatically recognizing that a person has entered the angle of view of the wide angle camera 25 or detecting an instruction to start of identification inputted by the person, waits for the person to stand still within the ranging area (step S2), and detecting that that person has stood still, measures the distance to the object b within the ranging area a of the range sensor (range finder) as shown in FIG. 4 (step S3). This measurement is performed for example a plurality of times to acquire an average value thus upgrading the ranging accuracy.

In the next step S24, the focus of the wide angle camera 25 is adjusted to the distance to the object to shoot an image of the object. In step S5, pattern recognition is used to determine whether the face of the object is in the image shot. In case the face of the object is not found, execution proceeds from step S5 to step S6 and the motor for tilt 21 of the iris image pickup apparatus 10 is driven so that the image pickup range c of the wide angle camera 25 will coincide with the optimum image pickup range c′ to capture an image of “face” as shown in FIG. 4. Execution then returns to step S4, lighting fixtures 14, 15 are illuminated and an image of the object is shot by the wide angle camera 25. The iris lighting fixtures 12, 13 are not illuminated then so that the image pickup range of the narrow angle camera does not cover the iris.

In case the face of the object is found in an image shot by the wide angle camera 25, execution proceeds from step S5 to step S7 to detect the position of the “right eye” or “left eye” of the shot image by way of pattern recognition. The motor for tilt 21 and the motor for panning 26 are fine-adjusted to orient the range sensor 24 to one of the “eyes”. At the same time, as shown in FIG. 5, arrangement is made so that the image pickup range of the narrow angle camera will cover an iris of the object. Further fine adjustment is made to the motors for panning 12a, 13a and motors for tilt 12b, 13b for illuminations so that the illuminating lights from the iris illuminating fixtures will focus on a target iris.

In the next step S8, forgery determination processing is made. In the forgery determination processing, as shown in FIG. 5, an enlarged image (iris image) of an eye captured within the image pickup range d of the narrow angle camera (telephotograph camera) 22 is shot with the iris illuminating fixtures 12, 13 turned on. Pupillary reflex is detected and if any, a shot iris image is passed to the iris identification apparatus, which performs iris identification in step S9, as detailed later.

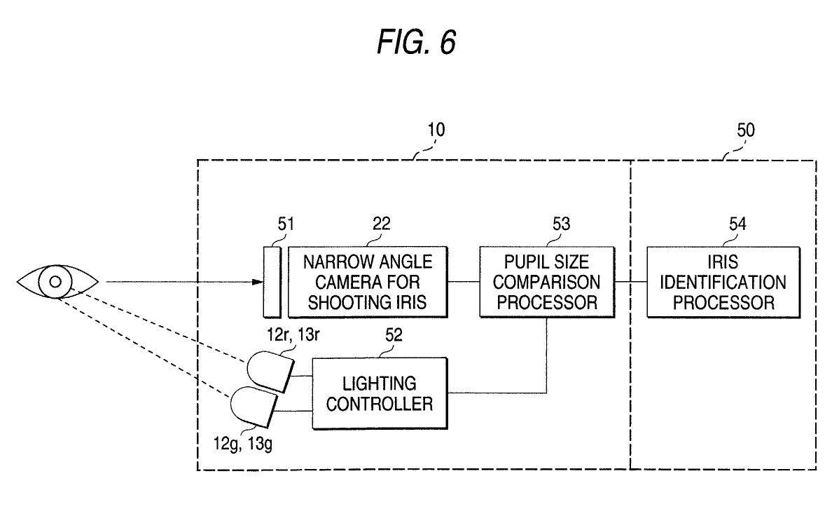

FIG. 6 is a block diagram of iris identification apparatus equipped with a pupillary reflex detection feature. The iris identification apparatus includes iris image pickup apparatus 10 explained in FIG. 1 and an identification processor 50. The iris image pickup apparatus 10 according to this embodiment includes, on top of the configuration explained in FIG. 1, a visible light cut filter 51 secured on the front face of the lens of the narrow angle camera 22, a lighting controller 52 for controlling light emitting diodes 12r, 13r for emitting a near infrared light and light emitting diodes 12g, 13g for emitting a visible light, and a pupil size comparison processor 53. The identification processor 50 includes an iris identification processor 54 for performing personal iris identification.

While the pupil size comparison processor 53 for detecting pupillary reflex is provided on the iris image pickup apparatus 10 in this embodiment, the pupil size comparison processor 53 maybe provided on the identification processor 50 for detection of pupillary reflex by the identification processor 50.

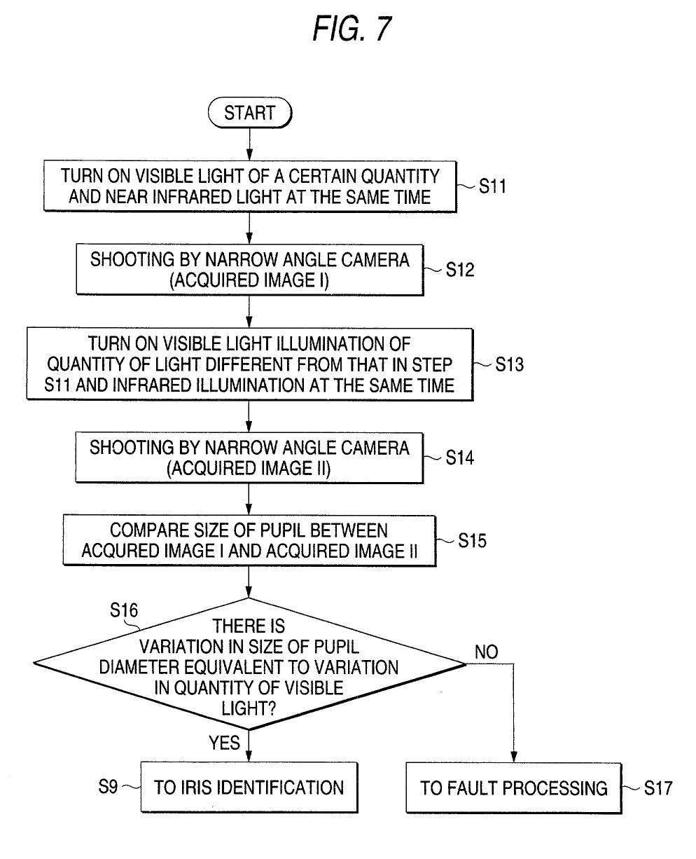

FIG. 7 is a flowchart showing the detailed procedure of the forgery determination step S8 shown in FIG. 3. In order to detect the presence of pupillary reflex prior to iris identification, visible illumination (light emitting diodes 12g, 13g illuminating in green) of a certain quantity of light (for example a large quantity of light) and infrared illumination (light emitting diodes 12r, 13r) of a predetermined quantity of light are turned on at the same time. The lighting fixtures 12 and 13 may be turned on at the same time while one of these may be turned on.

In the next step S12, an iris image is captured by using the narrow angle camera 22. The captured iris image is one acquired when a visible light of a large quantity illuminated the iris instantaneously, so that the pupil is contracted. The iris image is shot by using a near infrared light and the visible light is cut by the filter 51 so that the resulting image is a clear image optimum for identification and size comparison.

In the next step S13, visible light illumination of a quantity of light different from that in step S11 (for example a small quantity) and infrared illumination of a predetermined quantity of light are turned on at the same time. The resulting iris image is one acquired when a visible light of a small quantity illuminated the iris, so that the pupil is dilated.

In the next step S15, the iris image acquired in step S12 is compared with that acquired in step S14 to check whether the size of the pupil diameter has changed. In the next step S16, it is determined whether the variation in the size of the pupil diameter is equivalent to the variation in the quantity of a visible light. In case the iris image acquired by the narrow angle camera 22 has been forged, no variation in the pupil size is assumed. In case the iris image is the real one of the target person, the images acquired will show a variation in the size of the pupil corresponding to the quantity of light caused by pupillary reflex. Thus, in case the determination result of step 16 is affirmative (Yes), execution proceeds to step S9. In case negative (No), execution proceeds to step S17, where fault processing such as issuance of an alarm is made.

In case execution proceeds to step S9 of identification procedure, in the foregoing example, the iris image acquired in step S12 is passed to the identification process or as a target iris image. The iris image is one representing a contracted pupil and thus a larger iris area, which provides clear feature and shape used for personal identification. While it is also possible to acquire a target iris image in step 9, the foregoing approach is advantageous in that the processing time from acquisition of an iris image to iris identification is reduced by using an iris image acquired when the presence of pupillary reflex is determined. This eliminates unnecessary irradiation thus extending the service life of light emitting diodes used.

While a visible light of a large quantity is emitted in step S11 and a visible light of a small quantity is emitted in step S13, these steps may be reversed. Which step is to be used for large-quantity illumination is random rather than fixed in order to make it more difficult to cheat identification by forgery. The pupil size comparison processor 53 in FIG. 6 for executing steps S14, S15 in FIG. 7 has information from the illumination controller 52, so that a random order of large-quantity illumination and small-quantity illumination is not a problem; rather, it is obvious that the random-order approach avoids more errors in identification of forged images than the fixed-order approach.

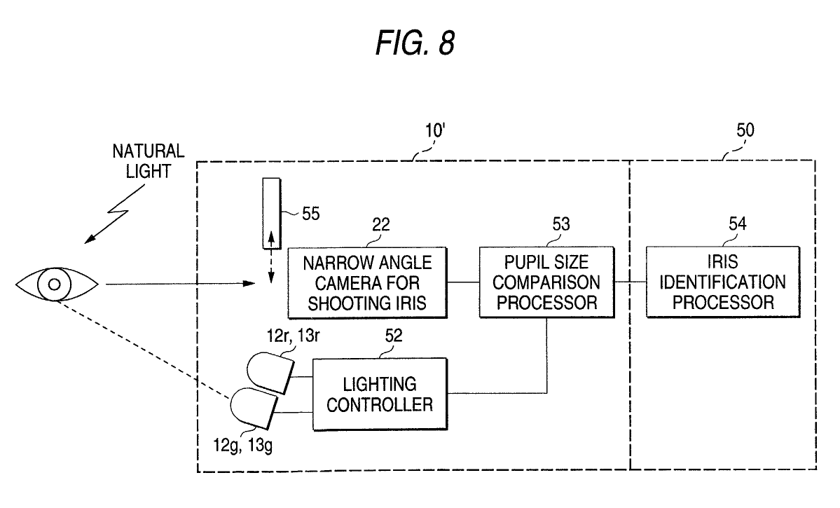

FIG. 8 is a block diagram of iris identification apparatus having a pupillary reflex detection feature according to another embodiment. While the filter 51 is fixed in the iris image pickup apparatus 10 in the embodiment shown in FIG. 6, the embodiment in FIG. 8 differs from that in FIG. 6 in that the visible light cut filter 55 is movable. The remaining configuration is the same as that in FIG. 6.

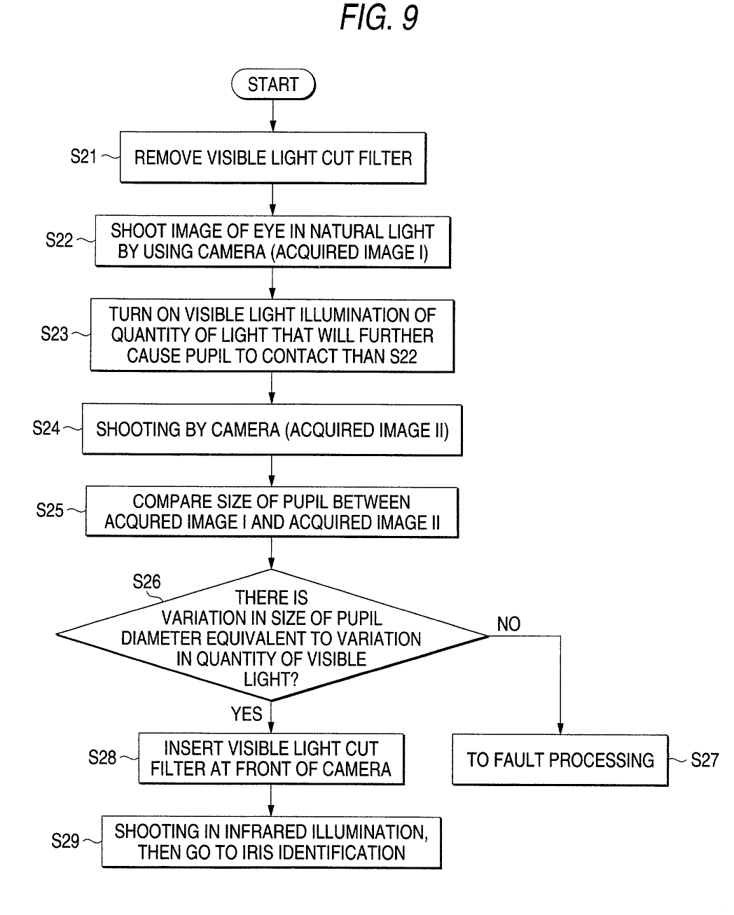

FIG. 9 is a flowchart showing the detailed procedure of step S8 shown in FIG. 3 in iris identification apparatus shown in FIG. 8. In this embodiment, the movable visible light cut filter 55 is removed from the front of the narrow angle camera 22 (step S21), and an iris image is acquired by using the narrow angle camera 22 (step S22). That is, an iris image is acquired in a natural light. An image pickup element in a natural light is photo-sensitive virtually in the visible light range alone. The filter 55 of the narrow angle camera 22 must be removed; otherwise a resulting image will be deep black.

In the next step S23, a light emitting diode 12g or 13g for irradiating a green visible light is turned on. The sensitivity of a human eye is the best around a wavelength of 500 nm that appears in green, green illumination as well as a natural light is condensed to irradiate onto an iris. This causes the pupil to contract more than in step 22. In the next step S24, an iris image with the pupil contracted is shot by using the narrow angle camera 22.

In the next step S24, an iris image acquired in step S22 (acquired image I) is compared with an iris image acquired in step S24 (acquired image II) to check whether a variation has taken place in the size of the pupil diameter. In the next step S26, it is determined whether the variation in the size of the pupil diameter is that equivalent to a variation in the quantity of light caused by addition of green illumination to the natural light. In case the iris image as a target image placed in front of the narrow angle camera 22 is a forged image, no variation in the pupil will be detected. In case the image is real, the pupil diameter will vary. Thus, when the determination result is negative (No), execution proceeds to step S27, where fault processing such as issuance of an alarm is made.

In case the determination result in step S26 is affirmative (Yes), execution proceeds to step S28, where the visible light cut filter 55 is inserted onto the narrow angle camera 22. Both the visible illumination and near infrared illumination are turned on to acquire an iris image, which is passed to the identification apparatus (step S29). A visible light is also provided in acquiring a target iris image, in order to cause the pupil to contract to increase the area of the iris thus facilitating personal identification, as described in the related art Japanese Patent Publication No. Hei. 11-346323 or Japanese Patent Publication No. Hei. 11-69219.

In this embodiment, iris images are shot three times in steps S22, S24 and S29 by using the narrow angle camera 22. Another configuration is possible where Step S29 is omitted and the visible light cut filter 55 is inserted at the front of the camera 22, then an iris image acquired with both light emitting diodes providing a visible light and a near infrared light respectively is used for both comparison of the pupil diameter size and personal iris identification. This configuration is preferable in that the number of the times iris images are acquired is reduced and the processing time shortened accordingly.

While the movable visible light cut filter 55 is provided in this embodiment, the visible light cut filter may be fixed as in the embodiment in FIG. 6 and a near infrared light may be used to illuminate an iris in the iris shooting in step S22, because of a high fault ratio of the apparatus incorporating a movable part.

As mentioned hereabove, the embodiment uses a visible light to detect pupillary reflex thus avoiding cheating in identification by forgery. A green light with good pupillary reflex and having a wavelength distant from that of a near infrared light required for iris image pickup. This attains both pupillary reflex and acquisition of a favorable iris image.

Lighting fixtures having a panning mechanism and tilt mechanism are used to irradiate a visible light and a near infrared light onto an iris. Further, a condensing lens for condensing an illuminating light onto an iris is used. This acquires accurate pupillary reflex and a favorable iris image by using an illumination light provided by a small power.

An iris image shot to check for pupillary reflex may be also used for identification. This reduces the processing time and power consumption of the illumination.

While two cameras, a wide angle camera and a narrow angle camera, are used in the embodiment, iris identification apparatus and iris image pickup apparatus using a combination of visible illumination and near infrared illumination is also feasible.

According to the invention, it is possible to obtain a favorable iris image and pupillary reflex at the same time, thereby providing an iris identification system that avoids cheating in identification by forgery.

What is claimed is:

1. An iris identification apparatus for performing personal identification by using a shot iris image comprising:
an image pickup unit for shooting a plurality of iris images, each of the plurality of iris images being shot under conditions where different quantity of a visible light included in an illuminating light is irradiated onto a person;
a pupil comparison unit for determining the presence of a variation in the pupil diameter in the plurality of iris images; and
an identification unit for performing personal identification by using anyone of said plurality of iris images in case a variation in said pupil diameter is determined.

2. The iris identification apparatus as claimed in claim 1, wherein one of the plurality of iris images is shot under a condition where a natural light as the illuminating light is irradiated to the person, and another one of the plurality of iris images is shot under a condition where an illuminating light including the natural light and a visible light is irradiated to the person.

3. The iris identification apparatus as claimed in claim 2, wherein the source of the visible light is a light emitting diode for emitting a green light.

4. The iris identification apparatus as claimed in claim 1 further comprising:
a light source including a light emitting diode for emitting a near infrared light; and
an illuminating light direction adjusting mechanism for simultaneously directing the near infrared light and the visible light toward an iris.

5. The iris identification apparatus as claimed in claim 1, wherein said identification unit adopts an iris image of an iris having the smallest pupil diameter among said plurality of iris images for determining the presence of a variation in the pupil diameter for the personal identification.

6. An iris image pickup apparatus for shooting an iris image used for personal identification, comprising:
an image pickup unit for shooting a plurality of images, each of the plurality of iris images being shot under conditions where different quantity of a visible light included in an illuminating light is irradiated onto a person; and
an pupil image selecting unit for determining the presence of a variation in the pupil diameter in the plurality of iris images and for passing at least one of the plurality of iris images to an identification processor as an iris image for personal identification in case that a variation in said pupil diameter is varied.

7. The iris image pickup apparatus as claimed in claim 6, wherein one of the plurality of iris images is shot under a condition where a natural light as the illuminating light is irradiated to the person, and another one of the plurality of iris images is shot under a condition where an illuminating light including the natural light and a visible light is irradiated to the person.

8. The iris image pickup apparatus as claimed in claim 6, further comprising a light emitting diode for emitting a green light as a source of said visible light.

9. The iris image pickup apparatus as claimed in claim 6, further comprising:
a light source as a light emitting diode for emitting a near infrared light; and
an illuminating light direction adjusting mechanism for simultaneously directing the near infrared light and said visible light toward an iris.

10. The iris image pickup apparatus as claimed in claim 6, wherein said pupil image selecting unit passes to said identification processor the iris image of an iris having a smallest pupil diameter among said plurality of iris images for determining the presence of a variation in the pupil diameter.

11. An iris identification method for performing personal identification by using a shot iris image comprising the steps of:
shooting a plurality of iris images under conditions of different quantity of a visible light included in an illuminating light irradiated onto a person;
determining the presence of a variation in the pupil diameter in the plurality of iris images; and
performing personal identification by using any one of said plurality of iris images in case a variation in said pupil diameter is determined.

12. The iris identification method as claimed in claim 11, wherein said step of shooting a plurality of iris images including the steps of:
shooting a first iris image under a condition where a natural light as the illuminating light is irradiated onto the person; and
shooting a second iris image a condition where an illuminating light including the natural light and a visible light is irradiated onto the person.

13. The iris identification method as claimed in claim 12, wherein the source of said visible light is a light emitting diode for emitting a green light.

14. The iris identification method as claimed in claim 11, wherein at least one of the plurality of iris images are shot under a condition where a near-infrared light and a visible light are directed to an iris of the person.

15. The iris identification method as claimed in claim 11, wherein an iris image of an iris having the smallest pupil diameter among said plurality of iris images is adopted in said step of performing personal identification.
